(19) United States
(12) Patent Application Publication
(10) Pub. No.: US 2017/0244444 A1
(43) Pub. Date: Aug. 24, 2017

(54) MOBILE LOCALIZATION IN VEHICLE-TO-VEHICLE ENVIRONMENTS

(71) Applicant: 5D Robotics, Inc., Carlsbad, CA (US)

(72) Inventors: David J. Bruemmer, Carlsbad, CA (US); Brandon Dewberry, Huntsville, AL (US); Josh Senna, Carlsbad, CA (US); Akshay Kumar Jain, Carlsbad, CA (US)

(73) Assignee: 5D Robotics, Inc., Carlsbad, CA (US)

(21) Appl. No.: 15/360,251

(22) Filed: Nov. 23, 2016

Related U.S. Application Data
(60) Provisional application No. 62/259,725, filed on Nov. 25, 2015.

(51) Int. Cl. H04B 1/7163; G01S 5/14; G01S 5/02; H04L 29/08; H04W 64/00

(52) U.S. Cl. CPC H04B 1/7163; H04L 67/12; H04W 64/00; G01S 5/0289; G01S 5/0284; G01S 5/14; H04W 84/005

(57) ABSTRACT

Recursive constellations of Ultra-Wide Band (“UWB”) transceivers are optimized based on a desired functionality or objective. By structuring transceivers of an UWB network into a plurality of subsets or constellations of UWB nodes each constellation can be optimized for a particular purpose while maintaining connectivity and cohesiveness within the overarching network. Implementations of specific functionality can be applied to Intra-Vehicle, Inter-Vehicle and Vehicle-to-Infrastructure constellations resulting in localized optimizations while maintaining a cohesive and coherent UWB network.

### RELATED APPLICATION

The present application relates to and claims the benefit of priority to U.S. Provisional Patent Application No. 62/259,725 filed 25 Nov. 2015 which is hereby incorporated by reference in its entirety for all purposes as if fully set forth herein.

### BACKGROUND OF THE INVENTION

Field of the Invention

Embodiments of the present invention relate, in general, to localization. propagation in both collaborative and non-collaborative environments, and more particularly to the propagation of localization information and the error associated with localization with respect to, among other things, Intra-vehicle, Inter-vehicle and vehicle-to-infrastructure environments.

Relevant Background

Ultra-Wide Band (“UWB”) is a wireless technology for transmitting large amounts of digital data over a wide spectrum of frequency bands using relatively low power over short distances. UWB transmitters can not only can carry a huge amount of data at very low power but also can carry signals through doors and other obstacles that tend to reflect signals at more limited bandwidths and a higher power.

UWB transceivers typically broadcast digital pulses that are timed very precisely on a carrier signal across a very wide spectrum (number of frequency channels) at the same time. In such an instance the transmitter and receiver must be coordinated to send and receive pulses and on any given frequency band that may already be in use, the UWB signal has less power than the normal and anticipated background noise so theoretically no interference is possible. Thus, unlike spread spectrum, UWB transmits in a manner that does not interfere with conventional narrowband and carrier wave transmission in the same frequency band.

A significant difference between conventional radio transmissions and UWB is that conventional systems transmit information by varying the power level, frequency, and/or phase of a sinusoidal wave. UWB transmissions transmit information by generating radio energy at specific time intervals and occupying a large bandwidth, thus enabling pulse-position or time modulation. The information can also be modulated on UWB signals (pulses) by encoding the polarity of the pulse, its amplitude and/or by using orthogonal pulses.

A significant application of UWB technology is precision locating and tracking applications. Specifically, precision locating and tracking of vehicles and corresponding applications to autonomous vehicles.

Vehicle-to-Vehicle (“V2V”), or connected-vehicle technology, is an emerging subdivision of UWB technology that incorporates sensor-equipped platforms to exchange data for myriad purposes, among these enhancing driver situational awareness and alerting drivers to potential collisions. These capabilities currently collect and process massive amounts of data from a virtually endless array of sources, and use this data to provide multitudes of position-relevant information to the driver and a host of other as-yet-undetermined applications.

Although connected-vehicle technology promises to be an integral part of the future growth of vehicle technology, generally, and within the automotive sector, specifically, many uncertainties exist within current connected-vehicle technology theories, among them bandwidth limitations and interoperability concerns. What is needed is a solution for functional mobile vehicle-to-vehicle localization optimization and propagation of accuracy data while mitigating the risk and eliminating the uncertainties associated with the bandwidth and path limitations. Moreover, the ability to link expansive constellations of UWB transceivers through a layered recursive network where sub-constellations are further optimized to achieve certain functionalities is both needed and desired.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

Recursive UWB constellations formed from subsets of UWB transceivers are optimized based a desired, local, functionality. In one or instances of the present invention update rate, locational accuracy and the means by which location is determined as well as the viable range to and scope of neighbor UWB transceivers with which to communicate is optimized. Accuracy and data among the constellations is propagated to maintain a cohesive and coherent UWB network.

One aspect of the present invention is a method for propagation of dimensional accuracy by a primary Ultra-Wide Band (“UWB”) node among a plurality of subsets of UWB nodes wherein the primary UWB node includes a primary location and a primary measure of accuracy associated with the primary location. The methodology includes receiving from each of the plurality of UWB nodes, node information such as the location of each node and a measure of locational accuracy associated with each node. The primary UWB node forms a list of the other UWB nodes wherein the list includes the location of each node and the measure of accuracy associated with the location of each node.

The primary node thereafter apportions is measure of accuracy into a plurality of error sectors and identifies error within a sector of accuracy to be minimized. The method continues by selecting from the list nodes a target UWB node that can diminish error associated with the target sector. Communications are established between the primary UWB node with the target UWB node, and, responsive to successive communication with the target UWB node, the primary location and the primary measure of accuracy of the primary node are revised.

Other features of the method described above include establishing subsets of the plurality UWB nodes wherein each subset identifies available UWB nodes within a predetermined range with which to communicate. Moreover, communications can be limited so as to be between the primary UWB node and the subset of the plurality of ultra-wide band nodes.

Selecting the target UWB node can also include optimizing the primary location in a spatial environment or in a relative environment. Selecting can also include iteratively comparing risk associated the primary measure of error associated with the primary location and an avoidance behavior between the primary UWB node and another node.

In the method presented above communicating can include receiving a time distance of arrival signal to determine positional accuracy. Similarly, communicating can include establishing a two-way ranging conversation. In the special case of doing both, the time distance of arrival signal and the two-way ranging conversation occur on independent simultaneous channels with the UWB location based on the two-way ranging conversation and the time distance of arrival signal being merged.

Another method for propagation of dimensional includes forming a plurality of subsets of UWB nodes wherein a first subset of UWB nodes includes a first measure of error, a first update rate, and a first range constraint among the first subset of UWB nodes. The method continues by forming a second subset of UWB nodes wherein the second subset of UWB nodes includes a second measure of error, a second update rate, and a second range constraint among the first subset of UWB nodes. Communication occurs between the first subset of UWB nodes and the second subset of UWB nodes such that the first subset of UWB nodes and the second subset of UWB nodes each act as a singular node and the subsets are linked to form a third subset of UWB nodes.

Within each subset the UWB nodes are optimized based on a functionality. In one instance, the functionality is an intra-vehicle functionality prioritizing update rate and measure of error over range between nodes. In another instance the functionality is an inter-vehicle functionality balancing measure of error and update rate based on range between nodes. In yet another instance the functionality is an infrastructure-to-vehicle functionality prioritizing range between nodes over update rate and accuracy. In each case the functionality of the subsets are independent.

The method can also include uniformly selecting by each node of the first subset of UWB a first mode of location identification based on the first functionality. Likewise, each node of the second subset of UWB nodes can select a second mode of location identification and the first mode of location identification is independent of the second mode of location identification.

Another aspect of the invention is that the first mode of location identification is reception of a time distance of arrival signal or establishing a two-way ranging conversation. It is also possible that the first mode of location identification includes receiving a time distance of arrival signal simultaneously with the two-way ranging conversation.

In the same light, the time distance of arrival signal and the two-way ranging conversation can occur on independent simultaneous channels and the location of each node in the first subset of UWB nodes can be based on a merger of the two-way ranging conversation and the time distance of arrival signal.

Another aspect of the claimed invention is that an asset can be associated with one or more subsets of UWB nodes and data shared with the asset can be limited to data shared only among the associated one or more subset of UWB nodes.

The method includes maintaining the functionality of each subset of UWB nodes and transforming the measure of error associated with the location from the first subset of UWB nodes to the second subset of UWB nodes.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The features and objects of the present invention and the manner of attaining them will become more apparent, and the invention itself will be best understood, by reference to the following description of one or more embodiments taken in conjunction with the accompanying drawings, wherein:

FIG. 1A shows a high-level view of recursive constellations of Ultra-Wide Band tags configured in a representative vehicular application, according to one embodiment of the present invention;

FIG. 1B shows a detailed view of an Intra-vehicular constellation of recursive Ultra-Wide Band tags as implemented according to one embodiment of the present invention to position an augmented reality headgear within the interior of a vehicle;

FIG. 2 shows an example of a relative data sharing environment among recursive constellations of Ultra-Wide Band tags, according to one embodiment of the present invention;

FIG. 3 presents a high-level view of a hybrid architecture for recursive constellations of Ultra-Wide Band tags, according to one embodiment of the present invention;

FIG. 4 depicts a measure of location accuracy relative to an Ultra-Wide Band tag in connection with similar tags within its environment with which it may interact to minimize same, according to one embodiment of the present invention;

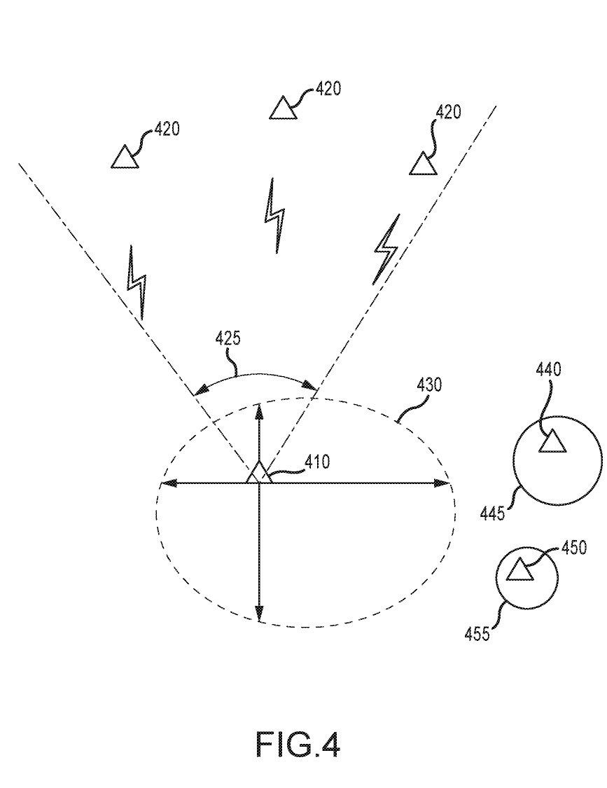

FIG. 5 is a flowchart of one methodology for establishing recursive constellations of Ultra-Wide Band transceivers, according to one embodiment of the present invention;

FIG. 6 is a flowchart of one methodology for identify a targeted node to minimize locational accuracy associated with a Ultra-Wide Band tag in recursive constellation, according to one embodiment of the present invention;

FIG. 7 is a flowchart of one methodology for initiating two-way ranging localization between Ultra-Wide Band tag in recursive Ultra-Wide Band constellations, according to one embodiment of the present invention;

FIG. 8 is a flowchart of one methodology for time distance of arrival as applied to recursive constellations of Ultra-Wide Band tag, according to one embodiment of the present invention,

FIG. 9 is a high-level block diagram of recursive constellation of Ultra-Wide Band tags according to the present invention; and

FIG. 10 is a representative computer environment suitable for implementation of recursive Ultra-Wide Band constellations of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

Recursive constellations of Ultra-Wide Band (“UWB”) transceivers (also referred to herein as tags or nodes) are optimized based on a desired functionality or objective. By structuring transceivers of an UWB network into a plurality of subsets or constellations of UWB nodes each constellation can be optimized for a particular purpose while maintaining connectivity and cohesiveness within the overarching network.

Embodiments of the present invention are hereafter described in detail about the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement accuracy, measurement accuracy limitations and other factors known to those of skill in the art, may occur in amounts that do not preclude the effect the characteristic was intended to provide.

Like numbers refer to like elements throughout. In the figures, the sizes of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that an element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

An objective of the present invention is optimizing functionality of a plurality of UWB tags to achieve a particular purpose while maintaining connectivity and cohesiveness with an overarching network. A fundamental function of an UWB tag is its ability to provide precise locational services. Unlike other positional resources, UWB tags can ascertain a very precise location of an object in austere environments. UWB signals are capable of penetrating buildings, soil and other obstacles that pose a problem to other positional resources such as the Global Navigation Satellite System (“GNSS”) and the like. Consequently, UWB signals are not prone to multipath errors that plague positional resources in urban settings. But the positional accuracy and versatility of UWB tags is not without its tradeoffs and a one-size-fits-all approach can place unnecessary limits an otherwise versatile resource.

In one embodiment of the present invention, two or more subsets of UWB tags within a UWB network of a plurality of UWB tags are formed into recursive UWB constellations. Recursive constellations are, for the purpose of this invention, constellations of UWB nodes wherein the solution to a particular problem depends on solutions to smaller instances of the same problem, such as positional determination and measure of locational accuracy. In each UWB constellation the UWB tags are optimized to provide positional information based on the objective of the constellation. While the physical hardware of the tags may remain consistent throughout a particular network, the protocols governing the implementation of the tags within a particular constellation can be modified and optimized based on desired outcomes.

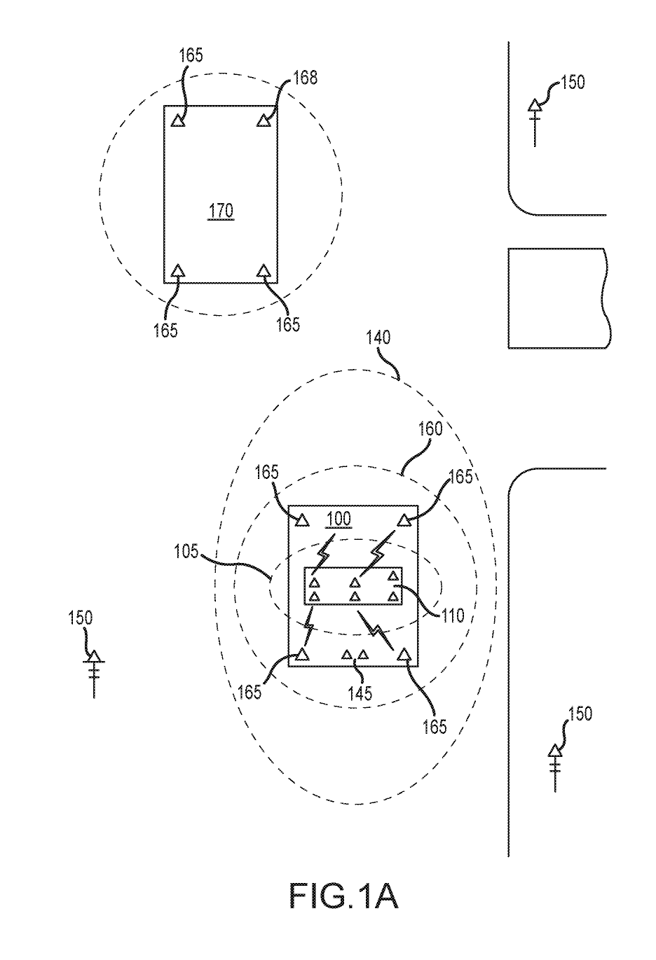

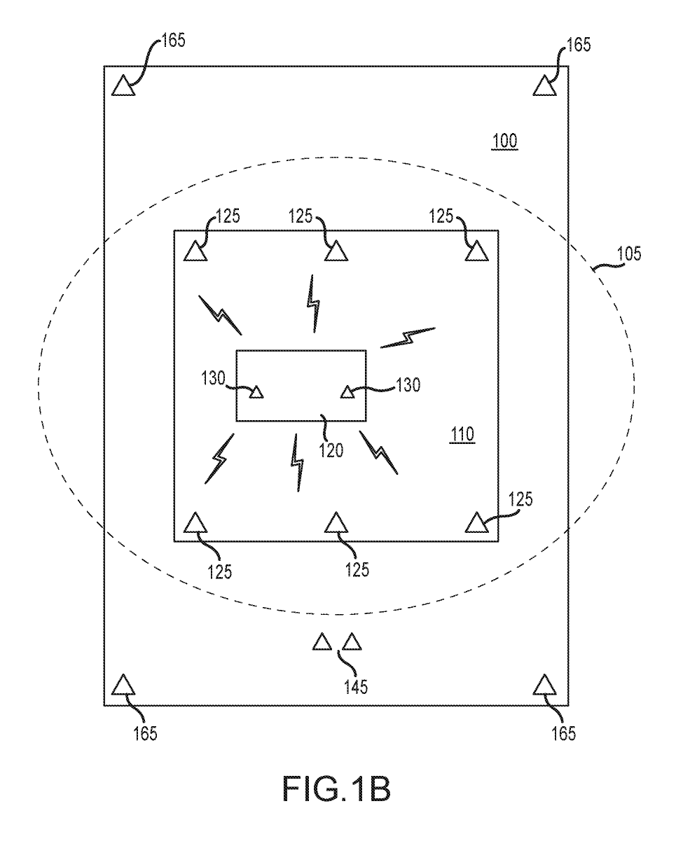

For example, FIG. 1A depicts a vehicular environment having three recursive constellations of UWB tags, according to one embodiment of the present invention. In the configuration shown in FIG. 1A, a first set of UWB tags are positioned within the interior 110 of a vehicle 100 to accurately ascertain the position of a virtual reality headgear 120 worn by a passenger. In other embodiments, the UWB tags may be used to identify the location of smart phone, watch or the like within the vehicle's interior. One of reasonable skill in the relevant art will appreciate that the examples set forth herein are merely illustrative and should not be interpreted to constrain the applicability of the presented concepts. While this examples exemplifies the use of UWB tags in a vehicular application, the principles described can be equally applied in other environments. Similarly, the present invention scales to includes a plurality of optimized constellations and the three constellations used in this example should not be interpreted as limiting by any means.

Turning to FIG. 1B, the tags 125 for the first constellation are positioned within the interior 110 of the car 100 so as to provide each tag with a direct line-of-sight with the objective of the constellation, the virtual reality headgear 120. In this case, the focus of the constellation, referred to hereafter as an intra-vehicle constellation 105, is to precisely know the location and angular orientation of a virtual headgear 120 when worn inside the vehicle. By placing the UWB tags in the headrest and/or near the rear-view mirror, (or similar locations) the tags 130 associated with the virtual headgear 120 are likely to possess a direct unimpeded view of each tag 125 associated with the interior 110 of the vehicle 100.

Augmented reality requires very precise location information that is frequently updated. Moreover, as the images presented are directly based on its location within the vehicle, the angular information associated with the headgear's 120 position is vitally important. And as suggested above, the location and orientation must be refreshed often. Therefore, the update rate at which position is determine must be high. By doing so, an individual wearing the headgear 120 can accurately interact with vehicle 100 and have images superimposed on the normal visual environment. For example, the headgear 120 may be akin to a set of glasses or goggles in which the user can see the environment outside the vehicle. The headgear 120 can thereafter augment the scene viewed by the user with additional data such as lane markers, obstacle warnings and so forth. Consider a foggy road in which it is difficult to see the road or a vehicle that is ahead on the highway. The googles, using the invention presented herein, can provide lines on the lens of the googles corresponding with the lanes markers of the road and outline a vehicle ahead long before it can be normally viewed through the fog.

Driving the UWB tags to achieve these parameters is not without its tradeoffs. Highly accurate positional determination and high update rates are accomplished at the cost of using short range line-of-sight transmissions. For example, multiple two-way communications between the tags 125 affixed to the car and those on the headgear 130 will provide more accurate information than simply receiving broadcast information. And as one of reasonable skill in the relevant art would appreciate this recipe for providing very precise positional information to a set of augmented reality goggles within a vehicle's interior 110 is not a recipe that would optimally identify the vehicles position on the road.

Accordingly, the invention forms another or a second constellation 140 of UWB tags whose functionality is focused on determining the location of the vehicle as it travels down the road. The reader should note that while a geospatial location of the car on the road is beneficial it is not necessary for many of the applications of the present invention. Rather the vehicle 100, in this case, is concerned with the local relative environment including the road and nearby obstacles.

Referring back to FIG. 1A, the second constellation 140 of UWB nodes (transceivers) can be positioned, in one embodiment, on the top of the vehicle in an antenna structure such as a shark fin 145. In this infrastructure configuration, also referred to herein as a Vehicle-to-Infrastructure or V-to-I constellation, the UWB tag(s) have minimal interference from the metal structure of the car as they ascertain their position from nearly nodes associated with lamp posts or other fixed pieces of fixed infrastructure. UWB tags associated with a lamp post 150 or fixed piece of infrastructure are survey and possess little to no locational error. Similarly, the tags 125 affixed to the interior of the car have no error with respect to the vehicle 100, however they inherently include any error that may be associated with the vehicle's location itself.

As described hereafter, the location of a UWB node can be determined using two-way conversations (Two Way Ranging) with other nodes as well as simply receiving signals broadcast by other nodes that includes positional and timing information (Distance Time of Arrival). The infrastructure constellation is, in this embodiment of the present invention, focused on the location of the vehicle with respect to the local environment. For this example, the environment is comprised of the road on which the vehicle travels as well as any known obstacles.

While an accurate location of the vehicle is important, the degree of accuracy can be sacrificed in favor of establishing long range communications. Thus, nodes within the infrastructure constellation 140, which position the vehicle in the local environment, are optimized to establish long range communication with and receive a signal from UWB tags positioned on light posts 150 or other fixed assets. The location of these assets is fixed having little to no error with respect to its location. Long range communication of this type decreases update rate necessary to provide intermittent spatial position corrections. And while the node with which communication is established has little to no error, the constellation accepts lower accuracy than would be required of the intra-vehicle constellation 105.

In one network model for vehicular applications, a sparse environment of infrastructure tags is created wherein intersections or areas of interest such as a bridge or tight curve include fixed infrastructure tags with which vehicles can communicate to gain positional data, but areas between the intersections or areas of interest are void of any tags and thus incapable of providing any positional information. In these areas, the positional accuracy of the vehicle degrades. For example, the accuracy of the V-2-I constellation may be 1.5 meters when in communication with two or more tags but degrades to 2.5 meters in between updates. As the vehicle regains connectivity with a fixed tag, accuracy is updated. But there are instances in areas in which no fixed tags are available get accuracy becomes increasingly important, such as the interaction between other vehicles on the same road. One of reasonable skill in the relevant art will also recognize the accuracy values presented above are illustrative and are used to convey the concept that locational accuracy may degrade between updates.

A third UWB constellation can therefore be focused on inter-vehicle interactions 160. One or reasonable skill in the relevant art can appreciate that each vehicle can, using a similar infrastructure constellation, position itself using fixed infrastructure tags. However, resources of this type may not allow for continual updates causing the positional accuracy to drift. And as one might expect, while a vehicle's precise position within a lane may not be critical, it is critical to avoid a collision with an oncoming vehicle 170.

This third constellation 160 of tags is optimized for inter-vehicle (V-2-V) communications. UWB tags 165 can, in this instance, be positioned in the forward and rear portion of the car and optimized for transmission and reception along the direction of travel. Unlike prior constellations, the accuracy requirements of the inter-vehicle constellation 160 vary. As two vehicles approach but remain separated by a significant distance, the positional accuracy requirement of the V-2-V constellation 160 may be consistent with that of the V-2-I constellation 140. During that period, range may be optimized and update rate deemphasized. The motion of the constellation however governs how it is configured. As the vehicles' separation diminishes accuracy becomes paramount and a more frequent update rate required. As the vehicles close, long range transceiver capability becomes less important. But, once the vehicle passes the V-2-V constellation must be reconfigured to its initial settings to seek out and identify the next oncoming vehicle. Inter-Vehicle communication, in such an instance, can provide each vehicle with an awareness of another vehicle's position and that possesses UWB capabilities. Such communication can also improve both vehicle's estimate of trajectory in both space and time to assist in avoidance determinations. And, as each vehicle transmits location and location error the recipient can use such data as a reference to update avoidance margins.

The three UWB constellations 105, 140, 160 described in this example are each optimized for a particular function. Yet each constellation is also a member of an overarching network of UWB tags. The intra-vehicle constellation 105 would be of little use if it could not adopt and rely on the position of the vehicle within its environment base on the V-2I constellation 140. And the V-2-V constellation 160 must not only detect and position the vehicle with respect to other vehicles as it moves down the road, but must nonetheless position itself accurately on the road.

Each of the UWB subsets of constellations interact with each other in a recursive manner. As described herein, and as well-known to one of reasonable skill in the relevant art, a UWB tag is aware of its location and a measure of accuracy associated with that location. The position of the vehicle based on the V-2-I constellation 140 therefore includes some measure of accuracy associated with that position as does the position of the headgear within the interior of the vehicle. A transform exists to convey the accuracy associated with the V-2-I tags 145 to the intra-vehicle tags 125. Similarly, a different transform exists to convey accuracy associated with the V-2-V 165 tags to the intra-vehicle tags 125. In doing so the UWB tags associated with the headgear 120 can precisely locate the headgear within the interior 110 of the vehicle 100 but also present an accurate depiction of the lanes of the road and an image of an oncoming vehicle.

Motion is another factor to consider. A constellation in motion is likely to possess greater error than one that is relatively fixed. And a change in motion, or acceleration of the constellation, is more prone to error than a constellation in a constant state of motion. Consider an environment having several vehicles, wherein each vehicle is itself a constellation. From the perspective of a vehicle passing another vehicle that is stopped at a traffic light, the constellation of the vehicle that is stopped is a “fixed” asset. The fixed vehicle still possesses some degree of error associated with its location that is likely greater than a surveyed infrastructure UWB node, however as compared to an oncoming vehicle or another vehicle in motion, the fixed vehicle offers a preferred data point.

Another consideration of each constellation is scalability. Scalability refers to the number of participating nodes in a particular constellation. In constellations requiring high update rates and precise locational accuracy, the optimal number of nodes within the constellation may be less than that of a constellation seeking long range, low update, lower accuracy results. Being able to prioritize which nodes are used for precise location is therefore required. For illustration of this concept reconsider the positioning of the virtual headgear in the interior of the vehicle shown in FIG. 1B. Assume that that affixed to the interior 110 structure of the vehicle 100 are 6 UWB tags. The tags may be positioned at each corner of the interior space, in the rear-view mirror, head rests, seats and the like. Further assume that to position the headgear 120 accurately the tags 130 on the headgear require direct line of sight with 4 UWB nodes. The headgear used by a person in the back seat would utilize different UWB nodes than the UWB nodes used by the driver. Yet each headgear 120 may have unobstructed view of all of the UWB nodes within the interior of the vehicle. One aspect of the invention is to prioritize and select with which nodes communication occurs.

While each UWB tag can identify its location and a measure of accuracy associated with that location to another UWB tag, they can also share data. Another aspect of the present invention is layered data sharing. Each asset positioned by a subset of UWB tags is provided with data consistent with its location. For example, the headgear in the prior example need not know the accuracy associated with a passing infrastructure node but rather simply the accuracy of the vehicle in which it is located.

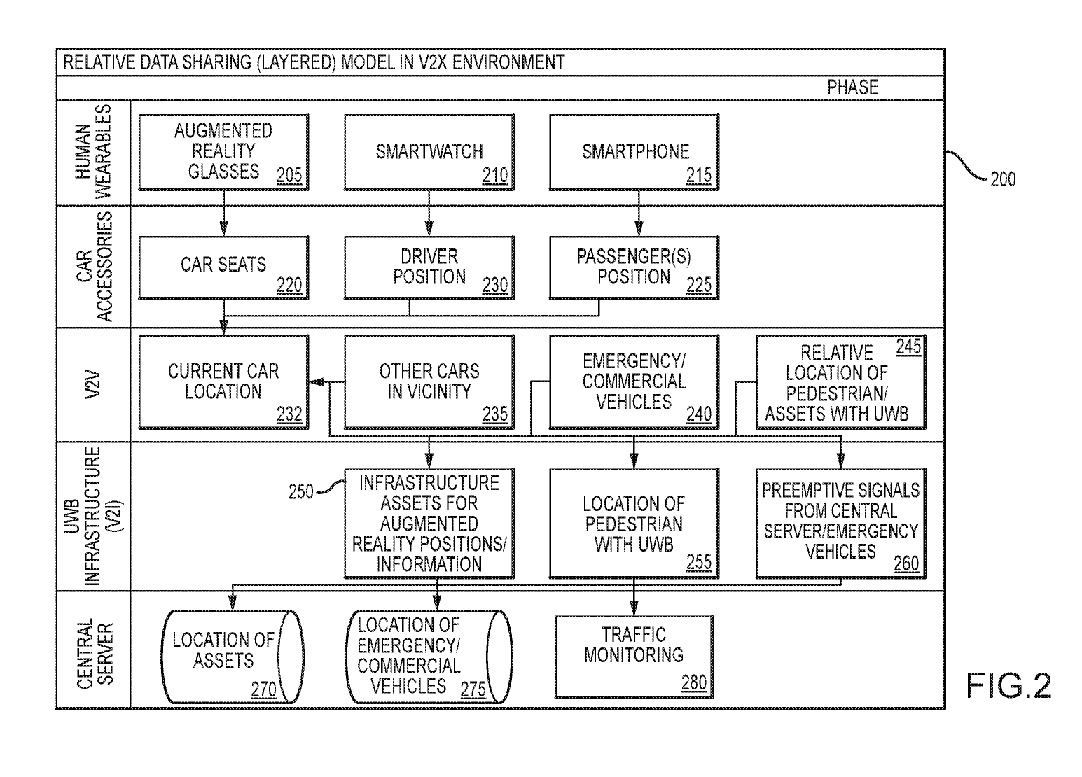

FIG. 2 is a high-level depiction of layered data sharing. Extending the example presented above with respect to three recursive UWB constellations shown in FIG. 1, a layered data sharing model is shown in a V-2-x environment. The example illustrates that a passenger 200 in the vehicle may have an augmented reality headgear 205 as well as a smart watch and smartphone 215. Each of these devices can position itself within the vehicle. The vehicle also knows the location of the car seats 220 and can differentiate the position of the car seat from that of the passenger seats 225. One application of the present invention may be to inhibit certain functions of the smart phone 210 if it is ascertained that the smart phone is associated with the driver's seat 230. For example, one application of the present invention can be to inhibit texting operations of the smart phone for the driver while phones located within the car and consistent with the position of a passenger would be fully operational.

Similarly, data associated with an augmented reality game 205 used by a passenger 225 may be inhibited when the same set of headgear 205 is worn by the driver 230. When the headgear is identified as being in a location consistent with the driver 230 information related to other cars 235, obstacles, emergency vehicles 240 and the like are presented and prioritized.

Another aspect of a layered approach to UWB constellations is sharing historical data. As a constellation interacts with other constellations of UWB nodes, they can share historical data. For example, as a vehicle approaches an oncoming vehicle the two inter-vehicle or V-2-V constellations interact. In addition to determining each vehicle's location so as to avoid collision, they two constellations can share data with respect their past tracked assets 235.

Assume that an oncoming vehicle conveys that it had recently interacted with numerous other vehicles approximately 2 miles ago, or in the other car's frame of reference, within the next 2 miles. These vehicles were positioned on the road and not moving or moving very slowly. The passing vehicle can pass to other vehicles direct information regarding slowing traffic or similar hazards immediately ahead. The information could also include data with respect to environmental conditions, road conditions, and the like. For example, if vehicles in the same direction of travel are all veering to the right based on an obstacle in the road, that information can be passed from vehicle to vehicle so that the driver is informed of an upcoming obstacle prior to the time the vehicle arrives.

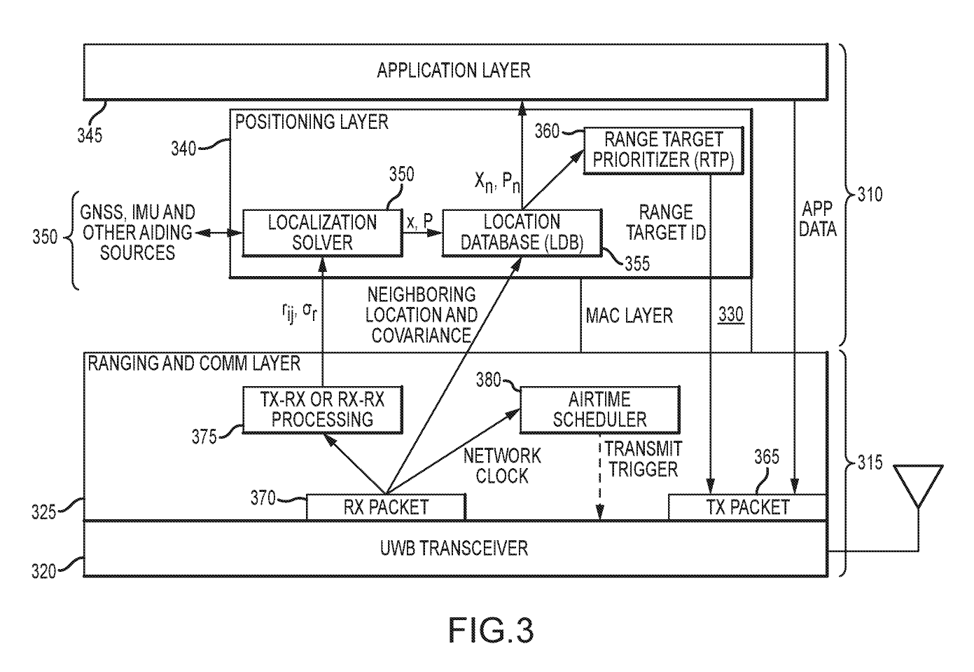

Fundamental to recursive UWB constellations is a UWB tag's ability to locate itself and to understand a measure of accuracy associated with that location. FIG. 3 presents a hybrid ranging architecture that UWB tags within a particular constellation can leverage based on the desired functionality of the constellation.

The architecture shown in FIG. 3 is implemented using sensors 305, a host 310 and a transceiver 315. As in many applications involving positional information, a variety of sensors 305 can be used to provide data used to refine an object's position, or sensors that can themselves be refined with input of positional data. GNSS, LIDAR, odometry, and the like are examples of such sensor data. Indeed, objects such as a vehicle would implement a host of sensory inputs to arrive at a best possible solution to its position.

The host 310 can be considered to be the object to which a location is assigned. The headgear would include a host processing capability as would each vehicle. Lastly the host would be associated with one or more radios 315 such as a UWB transceiver. The hybrid architecture of the present invention includes in the radio component 315 a transceiver 320 coupled to a ranging and communication layer 325 that is in turn mated with a MAC layer 330. These layers would reside on the radio and would facilitate range and Rx message processing as well as Tx processing when necessary.

The host 310 would also capture a positioning 340 and application 345 layer. The host uses these layers to identify and initiate which locational processes are warranted based on the constellation's functionality. The application 345 and positioning 340 layer can provide information to additional sensors as well as accept information to refine the host's location.

One aspect of the architecture of FIG. 3 is the ability of UWB tags to establish two-way ranging. In such an instance one radio (tag) transmits a request packet to another tag. According to the present invention there is one and only one designated target UWB tag. The target tag acquires the message, demodulates the packet and notes its precise time of arrival. After a precise and predetermined delay, relative to the time or arrival, the target tag sends a response to the tag originating the message. The requesting tag receives the response and notes the time of arrival of the response. Knowing this is a two-way communication with a precise respondent, the receiving tag calculates the total time from when the request was originally sent to when the response was received, subtracts the known delay and multiples the result by c/2.

To accomplish this task a localization module 350 residing in the host 310 generates a request for two-way ranging. Using a list of neighboring UWB nodes from the location database 355, the host 310 “selects”, and prioritizes, a target UWB node using the Range Target Prioritizes 360. With the target node identified, the host directs the radio to generate a Tx packet that is thereafter transmitted by the UWB transceiver.

The UWB transceiver of the target receives the Rx packet and the time of arrival is noted. The Rx packet is processed by a range processor and passed to the localization module of the receiving host which responds with a response Tx packet that is transmitted to the requesting UWB node after a predetermined delay directed by a scheduler. The response Tx packet is thereafter received by the original requesting transceiver.

The Rx packet is recognized by the Tx-Rx module a being in response to the original request. In this instance the Tx-Rx block computes the precise time delay between when this node sent (Tx'd) a range request packet and when it received (Rx'd) a response. It then converts this to a TWR distance measure (r), and a distance measurement error estimate (sigma_r), providing these to the localization block for updating current position. By noting the time of arrival and the time at which the original packet was sent, a distance to the target node can be determined. This single process provides a spherical range to the target node. By targeting separate nodes, a precise location can be determined.

Prioritizing and identify which node to target to gain a precise location is an important aspect of the present invention. All nodes know their location and a measure of accuracy associated with that location. Each time ranging occurs the result is folded in a node's estimate of its location and the measure of accuracy using a Bayesian technique using a weighted average of my own and additional sensor error.

The error is not uniform. Assume that the location of a node has been determined using the technique above using three other nodes. Each node is, from the perspective of the requesting node within a 45-degree forward sector. While the use of these three nodes would identify the requesting node's position, accuracy associated with that location along sectors approximately 90 degrees to the center of the forward sector would be greater than the error in the midpoint of the forward sector. Imagine if you will an ellipse representing the measure of accuracy associated with the location of the node. The major axis of the ellipse is substantially perpendicular to 45-degree forward sector meaning that error is minimized in the direction toward the nodes to which the ranging communication occurred. And while this examples uses a symmetric ellipse as a representation of accuracy, one of reasonable skill in the relevant art will appreciate that the measure of accuracy associated with a node is a Gaussian distribution.

The architecture of the present invention, knowing the location and measure of accuracy associated with each node within the constellation, selects the target node(s) to minimize the requesting nodes error. Turning back to the example above, the requesting node 410, knowing that it possesses substantially elliptical error distribution 430 would target a subsequent node 440, 450 substantially along the major axis of the ellipse. By doing so the resulting error distribution of the requesting node would be diminished. Recall however that each node 440, 450 possesses not only its location but a measure of accuracy 445,455 associated with that location. Accordingly, the requesting node may identify from the list of nodes, a node 440 whose location is in a direction that would help to diminish the requesting node's error, but the error of that node is substantial 445. Said differently, another node is recorded in the list as being in the right direction but the error is so great that it really doesn't know where it is. By considering both location and a measure of accuracy associated with each node the architecture of the present invention can select only those nodes 450 that will optimize the requesting nodes location.

The ability to selectively choose with which UWB nodes to range enables the update rate to increase thereby providing refined and reliable positional accuracy.

The architecture also recognizes that two-way ranging requires more time than simple determination of location based on Time Distance of Arrival (“TDOA”). An alternative method to two-way ranging, TDOA determines an object's location by merely receiving broadcast signals. In TDOA a plurality of nodes broadcast a signal at a precise time. The receiving UWB node receives two or more packets related to the same signal and notes each time of arrival. Knowing the location of the transmitting nodes and the different times that the same signal arrived at the receiving node, the receiving nodes location can be determined. When any two other nodes in the area perform a two-way ranging conversation a node can overhear both the request packet and the response packet and measures the time difference of arrival of each. This time difference along with the locations and location errors of these transmitters (which they included in their signal) is used by the Localization block for updating current position of the eaves dropping node.

TDOA is not as selective as two-way ranging but by only needing to receive signals it enables passive location determination. The present invention users each of these locational techniques separately or in combination to ascertain the best possible location of a UWB node. Depending on the accuracy requirements and update rates levied by the desired functionality of a constellation, the present invention modifies each tag's ability to determine its location and the measure of accuracy associated with that location.

Included in the description are flowcharts depicting examples of the methodology which may be used to propagate positional accuracy in recursive constellations of UWB nodes. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

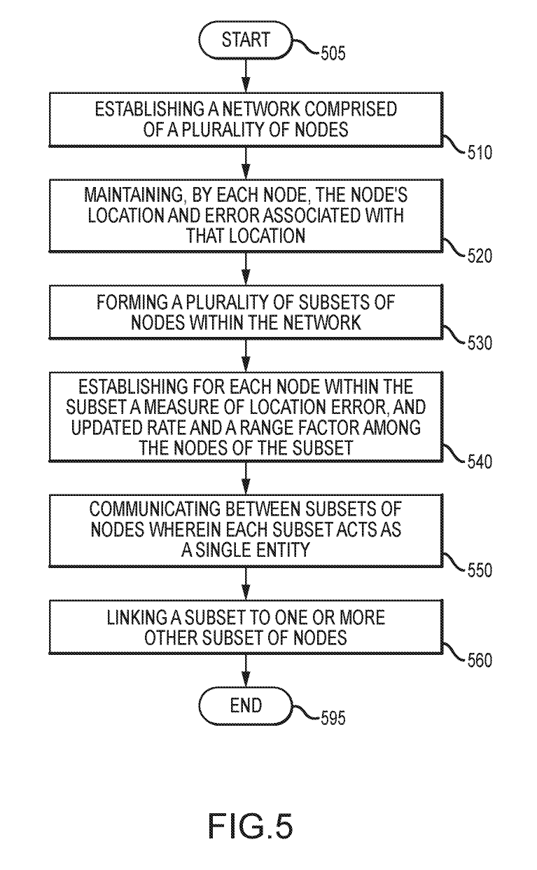

FIG. 5 presents a flowchart of a method embodiment for recursive constellations of UWB nodes, according to one embodiment of the present invention. The method begins 505 with the establishment 510 of a network comprised of UWB nodes. Each node within the network maintains 520 its location and a measure of accuracy associated with that location. From within this network of nodes, a plurality of subsets of nodes are formed 530.

Each subset is optimized for a particular functionality by establishing 540 for each node within that subset, a measure of accuracy associated with each node's location, an update rate for location determination, and a range constraint factor by which to constrain the nodes in the network to whom the nodes of this particular subset can communicate.

Communication 550 between the nodes within the subset is established as is communication with certain nodes of neighboring subsets. With communications established between the subsets, the subsets are linked 560 forming a cohesive network of recursive UWB constellations.

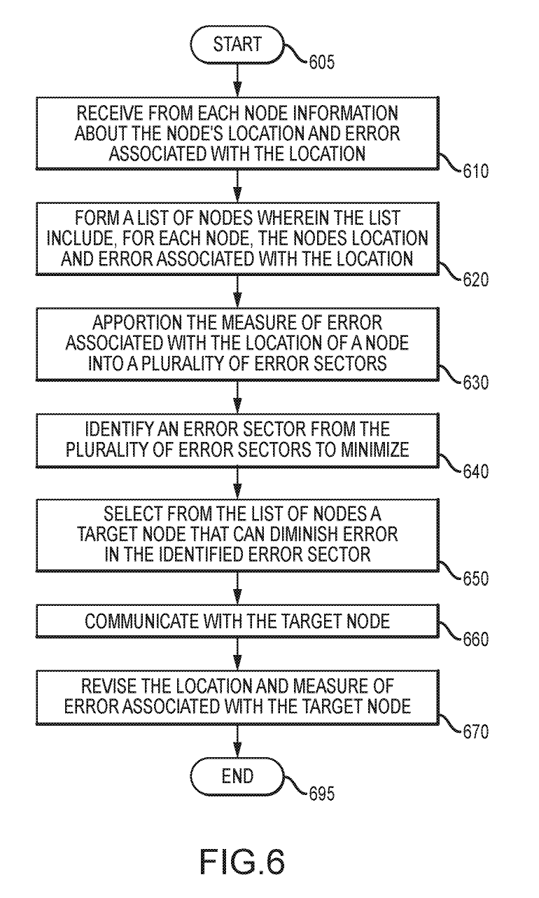

One aspect of the present invention is the ability to identify target nodes with which to interact to minimize locational error. The flowchart of FIG. 6 outlines the process by which the measure of location error is minimized according to one embodiment of the present invention.

Such a process begins 605 with receiving 610 from each node within the constellation, or within the UWB network as a whole, node information including the location of each node a measure of accuracy associated with that location. Each node within the network creates 620 a list of nodes within its constellation and within the network.

The node seeking to minimize the error associated with its location apportions 630 the error into a plurality of error sectors and, thereafter, identifies 640 which error sector to minimize. Once the error sector to be minimized is selected the node returns to the list of nodes within the constellation and network to select 650 a target node that can diminish that error. Communication 660 with the target node is established so as to provide precise location. In one embodiment of the present invention, two-way ranging is employed to provide precise locational data between the requesting node and the target node.

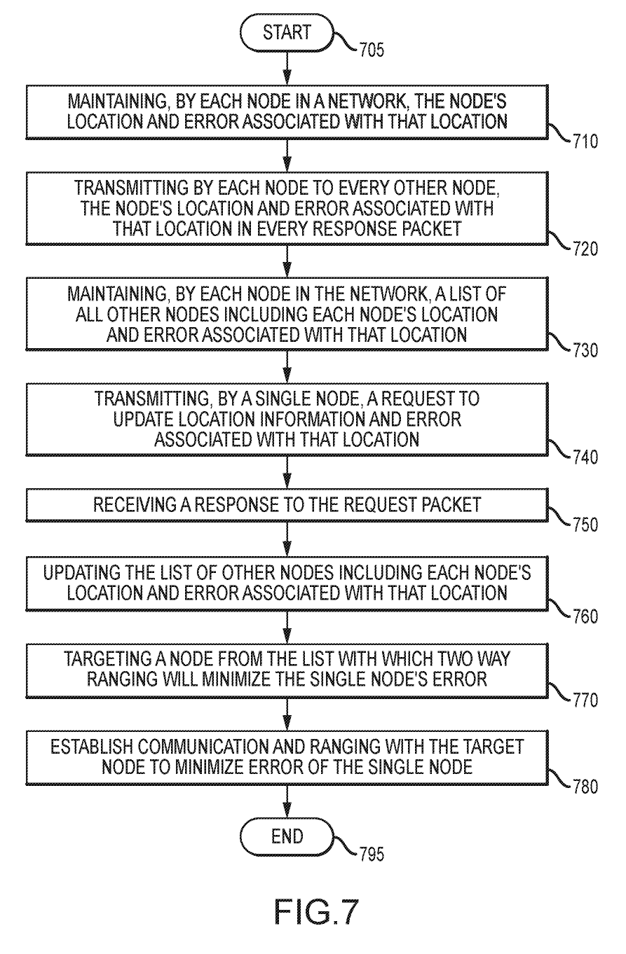

Based on the information gained from the target node, the error associated with the requesting node is revised 670. The process of two-way ranging is further described in flowchart shown in FIG. 7. As introduced above the process starts with the maintenance 710, by each node, of the node's location and the error associated with the node's location.

Each node transmits 720 to every other node its location and its corresponding error so that each node within the network can maintain 730 a list of nodes, their location and the error associated with that location.

As a node decides to refine its location or to minimize error associated with its location, it seeks to update 740 its list of nodes and the list of errors. Upon receiving 750 new information and updating 760 its list of nodes, a target node is selected 770. A node is targeted based on its location and the error associated with that location. For example, if a node in the network determines its locational accuracy along a certain axis should be improved, it will turn to the list of other nodes in the network to identify nodes within range that are along that particular axis of interest. If there are, for example, 5 nodes along the axis of interest, the requesting node may thereafter examine the accuracy associated with each nodes location to identify a node along the axis of interest and which possesses a relatively low measure of error with respect to that location. In some cases, a node may sacrifice the axis of interest in favor of a target node within minimal error as opposed to a node being closely aligned with the axis of interest yet possessing substantial ambiguity as to its true location.

Once a target node is selected two-way ranging 770 is accomplished by transmitting a request packet to the target node. The target node responds after a precise and predetermined delay by sending a response packet and the measure of accuracy of the requesting node is revised 780.

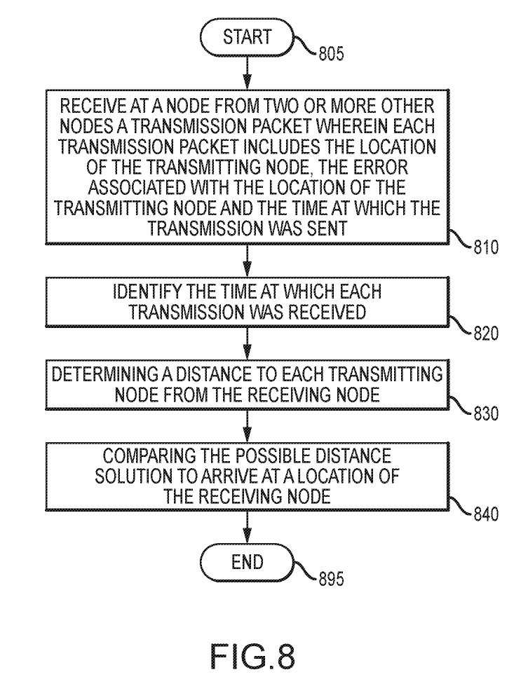

The steps of TDOA are reflected in the flowchart shown in FIG. 8. TDOA beings 805 with the receipt 810 by a node of two or more transmission packets. Each packet includes the node's location, the accuracy associated with that location and the time of transmission.

The receiving node notes 820 the time at which each packet is received and notes which packets are identified as being transmitted at the same time. As the location of the transmitting node is known and the time at which the signal is received is known, the distance 830 to each transmitting node is determined. At a single instance in time the ranges to two or more transmitting nodes are compared 840 to arrive at a location of the receiving node.

Recursive constellations of UWB transceivers can be optimized based on a desired functionality. The present invention structures transceivers of an UWB network into a plurality of subsets or constellations of UWB nodes wherein each constellation can be optimized for a particular purpose while maintaining connectivity and cohesiveness within the overarching network. Among each constellation data can be shared and location determination can be optimized using separate channels and a targeted approach. Among myriad possible optimization schemes, notably these recursive UWB constellations can easily be optimized for: 1) speed of motion; 2) number of relevant neighbors; 3) longest range and/or proximity of relevant neighbors; 4) data rate; 5) positioning update rate; 6) resolution of position update; 7) accuracy of position update; 8) worst-case reliability-of-position update; 9) depth information (i.e. three-dimensional accuracy); 10) projected collision probability; and the like. One of reasonable skill in the relevant art will recognize that in each example presented herein the optimization of a recursive constellation can include any combination of the aforementioned schemes. While demonstrative of the concepts presented herein, these descriptions are exemplary and not to be construed as limiting in any way.

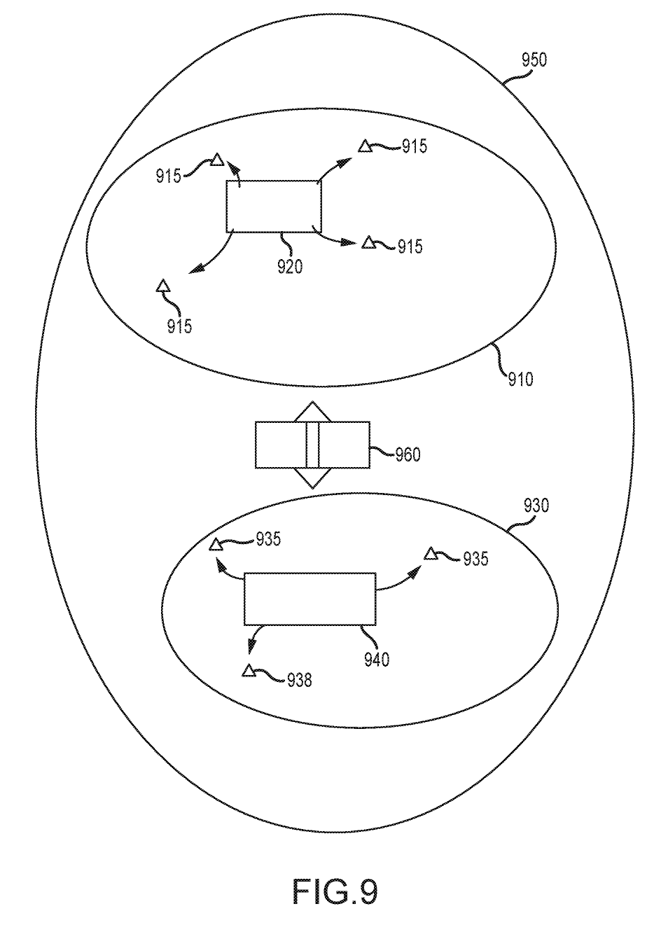

FIG. 9 illustrates a high-level block diagram view of recursive constellations of UWB nodes according to the present invention. The network shown in FIG. 9 includes a plurality of UWB transceivers allocated to two subsets or constellations. A first subset of UWB tags 910 comprises four UWB tags 915. Each of the UWB tags 915 within the first subset (or constellation) is communicatively coupled to a first subset configuration protocol 920. The first subset configuration protocol directs each UWB tag to, among other things, adhere to certain update rates, gain location information using certain communication processes with other tags and constrain the scope of UWB tag with which it interacts. The first subset configuration protocol is based on particular functionality fixed for the first subset 910

Likewise, a second subset of UWB tags 930 comprises 3 USB tags 935. And as with the first subset of UWB tags, the second subset of UWB tags 930 are each 935 communicatively coupled with a second subset configuration protocol 940 that directs each UWB tag 935 to adhere to certain update rates, gain location information using certain communication processes with other tags and constrain the scope of UWB tag with which it interacts based on particular functionality fixed for the second subset 930.

Each constellation of UWB tags 910, 930 is linked by a set of transforms 960 that enable the first subset of UWB tags 910 and the second subset of UWB tags 930 to interact and share information and to ultimately form a third constellation 950. One of reasonable skill in the relevant art will appreciate that the nesting and formation of UWB constellation can be scaled to achieve a plurality of functionalities while maintaining a cohesive and coherent network. Functionality such optimized positional determination for intra-vehicle operations as well as inter-vehicle or V-2-infrastructure operations are contemplated by the present invention.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

Portions of the present invention can be implemented in software. Software programming code which embodies the present invention is typically accessed by a microprocessor from long-term, persistent storage media of some type, such as a flash drive or hard drive. The software programming code may be embodied on any of a variety of known media for use with a data processing system, such as a diskette, hard drive, CD-ROM, or the like. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform particular tasks or implement particular abstract data types. Moreover, those skilled in the art will appreciate that the invention can be practiced with other computer system configurations, including hand-held devices, multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

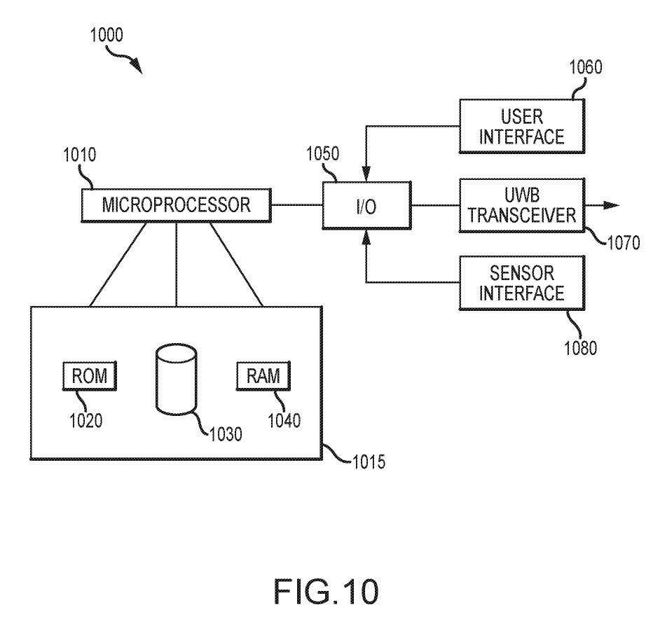

An exemplary system, shown in FIG. 10, for implementing the invention a general-purpose computing device 1000 such as the form of a conventional personal computer, a personal communication device or the like, including a processing unit 1010, a system memory 1015, and a system bus that communicatively joins various system components, including the system memory 1015 to the processing unit. The system bus may be any of several types of bus structures including a memory bus or memory controller, a peripheral bus, and a local bus using any of a variety of bus architectures. The system memory generally includes read-only memory (ROM) 1020, random access memory (RAM) 1040 and a non-transitory storage medium 1030. A basic input/output system (BIOS) 1050, containing the basic routines that help to transfer information between elements within the personal computer, such as during start-up, is stored in ROM. The personal computer may further include a hard disk drive for reading from and writing to a hard disk, a magnetic disk drive for reading from or writing to a removable magnetic disk. The hard disk drive and magnetic disk drive are connected to the system bus by a hard disk drive interface and a magnetic disk drive interface, respectively. The drives and their associated computer-readable media provide non-volatile storage of computer readable instructions, data structures, program modules and other data for the personal computer. Although the exemplary environment described herein employs a hard disk and a removable magnetic disk, it should be appreciated by those skilled in the art that other types of computer readable media which can store data that is accessible by a computer may also be used in the exemplary operating environment. The computing system may further include a user interface 1060 to enable users to modify or interact with the system as well as a sensor interface 1080 for direct collections of sensor data and a transceiver 1070 to output the data as needed.

While there have been described above the principles of the present invention in conjunction with accuracy propagation in recursive UWB constellations, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

1. A method for propagation of dimensional accuracy by a primary Ultra-Wide Band (“UWB”) node among a plurality of UWB nodes wherein the primary UWB node includes a primary location and a primary measure of error associated with the primary location, the method comprising
receiving from each of the plurality of UWB nodes, node information wherein node information includes a location of each node and a measure of error associated with the location of each node;
forming by the primary UWB node a list of the plurality of UWB nodes wherein the list includes for each node the location of each node and the measure of error associated with the location of each node;
apportioning the primary measure of error of the primary UWB node to a plurality of error sectors;
identifying by the primary UWB node a target error sector from the plurality of error sectors to be minimized;
selecting from the list of the plurality of UWB nodes a target UWB node that can diminish error associated with the target error sector of the primary UWB node;
communicating by the primary UWB node with the target UWB node; and
responsive to successive communication with the target UWB node, revising for the primary node the primary location and the primary measure of error.

2. The method for propagation of dimensional accuracy according to claim 1, further comprising establishing subsets of the plurality UWB nodes wherein each subset identifies available UWB nodes within a predetermined range with which to communicate.

3. The method for propagation of dimensional accuracy according to claim 2, further comprising limiting communication between the primary UWB node and a subset of the plurality of ultra-wide band nodes.

4. The method for propagation of dimensional accuracy according to claim 1, wherein selecting the target UWB node includes optimizing the primary location in a spatial environment.

5. The method for propagation of dimensional accuracy according to claim 1, wherein selecting the target UWB node includes optimizing the primary location in relative environment.

6. The method for propagation of dimensional accuracy according to claim 1, wherein selecting the target UWB node includes minimizing error in the target error sector.

7. The method for propagation of dimensional accuracy according to claim 1, wherein selecting includes iteratively comparing risk associated the primary measure of error associated with the primary location and an avoidance behavior between the primary UWB node and another node.

8. The method for propagation of dimensional accuracy according to claim 1, wherein communicating includes receiving a time distance of arrival signal.

9. The method for propagation of dimensional accuracy according to claim 1, wherein communicating includes establishing a two-way ranging conversation.

10. The method for propagation of dimensional accuracy according to claim 9, wherein communicating includes receiving a time distance of arrival signal simultaneously with the two-way ranging conversation.

11. The method for propagation of dimensional accuracy according to claim 9, wherein the time distance of arrival signal and the two-way ranging conversation occur on independent simultaneous channels and wherein the primary UWB location based on the two-way ranging conversation and the time distance of arrival signal are merged.

12. The method for propagation of dimensional accuracy according to claim 8, wherein the primary node receives from each of two or more targeted nodes a transmission signal, the transmission signal including a location of each targeted node and measure of error associated with the location, and wherein the primary node combines a measures a time of arrival of each of the transmission signals into a time difference of arrival and wherein the primary node updates the primary location and error associated with the primary location.

13.-31. (canceled)

32. A network of recursive constellations of UWB nodes, wherein each UWB node includes a location and a measure of error associated with the location, an update rate and a range constraint to nearby UWB nodes, comprising;
a first subset of UWB nodes;
a first subset configuration protocol including, for each UWB node within the first subset of UWB nodes, a first measure of error, a first update rate, and a first range constraint among the first subset of UWB nodes;
a second subset of UWB nodes;
a second subset configuration protocol including, for each UWB node within the second subset of UWB nodes, a second measure of error, a second update rate, and a second range constraint among the first subset of UWB nodes, wherein the first subset configuration protocol is associated with a first functionality and the second subset configuration protocol is associated with a second functionality; and
a set of transforms linking the first subset of UWB nodes to the second subset of UWB nodes to form a third subset of UWB nodes.

33. The network according to claim 32, wherein the first subset configuration protocol includes settings to optimize the first measure of error, the first update rate, and the first range constraint based on the first functionality.

34. The network according to claim 32, wherein the second subset configuration protocol includes settings to optimize the second measure of error, the second update rate, and the second range constraint based on the second functionality.

35. The network according to claim 32, wherein the first functionality is an intra-vehicle functionality prioritizing update rate and measure of error over range between nodes.

36. The network according to claim 35, wherein the second functionality is an inter-vehicle functionality balancing measure of error and update rate based on range between nodes.

37. The network according to claim 35, wherein the second functionality is an infrastructure-to-vehicle functionality prioritizing range between nodes over update rate and accuracy.

38. The network according to claim 32, further comprising a first asset associated with the first subset and wherein data shared with the first asset is limited to data shared among the first subset of UWB nodes.

39. The network according to claim 32, wherein the set of transforms forms a unified environment.

40. The network according to claim 32, wherein the set of transforms maintains the first functionality associated with the first subset of UWB nodes and the second functionality associated with the second subset of UWB nodes.
